(19) United States
(12) Patent Application Publication
(10) Pub. No.: US 2013/0000681 A1
(43) Pub. Date: Jan. 3, 2013

(54) METHOD OF CLEANING BEER KEGS, BREWERY, WINERY AND DAIRY PROCESS EQUIPMENT

(75) Inventors: Dana J. Johnson, Arvada, CO (US); Terry L. McAninch, Westminster, CO (US)

(73) Assignee: BIRKO CORPORATION, Henderson, CO (US)

(21) Appl. No.: 13/541,596

(22) Filed: Jul. 3, 2012

Related U.S. Application Data
(63) Continuation-in-part of application No. 12/586,174, filed on Sep. 18, 2009, now Pat. No. 8,211,239.
(60) Provisional application No. 61/192,572, filed on Sep. 19, 2008.

(51) Int. Cl. C11D 3/60; B08B 9/08

(52) U.S. Cl. 134/22.19; 510/218

(57) ABSTRACT

A method for cleaning used storage or processing liquid containers employing an aqueous solution of phosphoric acid, nitric acid and one or more surfactants, e.g., a detergent and/or wetting agent. Preferably, the aqueous cleaning solution has a total nitric acid content of 12 wt % or less. Complete cleaning can be achieved without using any caustic. The cleaning solution can be recycled repeatedly to clean multiple containers on numerous occasions over a period of time, e.g., several weeks.

### RELATED INVENTIONS

This application is a continuation-in-part of U.S. Pat. No. 8,211,239, filed on Sep. 18, 2009, which claims priority from provisional patent application Ser. No. 61/192,572 filed on Sep. 19, 2008, both of which are incorporated by reference herein.

### FIELD OF THE INVENTION

The present invention relates to an improved method for cleaning used processing and storage containers, such as beer kegs, liquid serving tanks, dairy tanks, and wine steel tanks, so that they can be reused, refilled and/or redistributed without contamination from the after-effects of prior use.

### BACKGROUND INVENTION

Various industries (e.g., wineries, breweries, and dairies) use liquid processing and storage containers to make, process, or dispense liquid products. Byproducts of storage and/or processing of these products must be removed in order to reuse the containers.

Although brewers supply beer in bottles and cans as individual servings, a significant amount of beer is supplied in larger sized kegs (1/2 barrel, or 15.5 gal.) or half kegs (1/4 barrel or 7.75 gallon) and 0.6 barrel (i.e., 5 gallon) kegs. Kegs are convenient for breweries, distributors and users storing, chilling, and transporting beer. They are also a convenient means to dispense multiple servings through a tap attached to the keg. Kegs are particularly useful for dispensing beer in commercial establishments and at events.

A significant disadvantage of using kegs is that they are difficult to clean, sanitize, and reuse. The unused beer and protein inside the dark wet keg is a perfect environment for microorganisms to incubate and grow. In addition, the other components of the unused beer form “soil” and may contain “beerstone,” which is very difficult to remove. Microorganisms, soil and beerstone must be cleaned from the keg before reuse. Otherwise, there is a potential for risk of contamination, off-flavors and even health risks to the consumer. Beerstone harbors microorganisms, making the inside surface of the keg impossible to sanitize. Accordingly, the keg must be cleaned effectively, and the cleaning process itself should not leave a chemical residue. All of this must be accomplished in an economical manner.

Cleaning kegs in breweries has traditionally been accomplished by using hot water and alkaline liquid cleaning solutions comprised of sodium and/or potassium hydroxide. Sodium hydroxide (NaOH) and potassium hydroxide (KOH) utilize extremely high (e.g., 12-14) pH to hydrolyze (i.e., break down) soil to remove it. Sodium hydroxide o known as “caustic soda” or “lye” and potassium hydroxide is known as “caustic potash.” In the last few decades, formulators have included surfactants (i.e., detergents) sometimes chlorine bleach (i.e., sodium hypochlorite) or hydrogen peroxide along with the caustic to assist wetting and protein removal. Caustic cleaning solutions are used in the brewery because they are relatively inexpensive, can be recycled (i.e., re-used) and do a good job of removing protein-based soils. They do not, however, address calcium and magnesium hard water scale deposits nearly as well as acidic cleaning solutions. Like steam cleaning, which is also employed in some keg cleaning operations, the use of caustics presents hazards to workers who must handle or come in contact with those chemicals.

A decade ago, craft brewers began using a new generation of non-caustic, alkaline, oxygenated cleaning solutions instead of using caustic. These powdered non-caustic alkaline cleaners are safer for employees than their caustic predecessors due to their lower pH at the point of use. But non-caustic cleaners tend to cost more per pound than caustics. Also, they do not remove, and perhaps even promote, beerstone. “Beerstone” is a hard organo-metallic scale that deposits on fermentation equipment and is chiefly composed of calcium oxalate or (C₂CaO₄). Accordingly, many brewers still use caustic cleaners in conjunction with the non-caustic cleaners to obtain complete removal of protein soil and beerstone. Cleaning with acid can be used as well, but breweries either use caustic, then neutralize with acid, or use acid only as a remedial step to remove beerstone.

Other industries also require cleaning and recycling of containers for further use. For example, in the dairy industry, milk-stone deposits can create problems. Milk-stone deposits are deposits of calcium and magnesium phosphates, protein, etc., that are produced when milk is heated to temperatures above 60° C. Hard deposits of milk residues that accumulate on imperfectly cleansed dairy utensils serve as a substrate for bacteria and contributes off-flavors to milk.

Likewise, in the wine industry, calcium is added in the form of calcium bentonite for treating must or wine, calcium carbonate is added for deacidification purposes and even as a contaminant in saccharose used for chaptalization, all of which may cause an increase in the calcium tartrate content of wine making and storage equipment. Calcium tartrate is a relatively insoluble salt that must be removed to reuse wine making and storing equipment.

In addition to the foregoing considerations, the spent cleaning solution must be environmentally friendly when discharged. Even more preferably, the cleaning solution should be capable of being recycled, which minimizes environmental impact and decreases the cost of the cleaning operation.

Thus, a need exists for providing an improved means for cleaning kegs, other liquid containers, and brewery/dairy/winery equipment that is effective, safe, inexpensive and environmentally friendly.

### SUMMARY OF THE INVENTION

It has now been found that these needs can be met by cleaning liquid storage or processing containers (such as beer kegs, wine steel tanks, or dairy steel tanks) with an aqueous solution of phosphoric acid, nitric acid and one or more surfactants, e.g., a detergent and/or wetting agent. Preferably, the aqueous cleaning solution has a total nitric acid content of 12 wt % or less. Complete cleaning can be achieved without using any caustic. The solution is economically superior to prior cleaning solutions. Surprisingly, the cleaning solution can be recycled repeatedly to clean multiple containers on numerous occasions over a period of time, e.g., several weeks.

### DETAILED DESCRIPTION OF THE INVENTION AND A PREFERRED EMBODIMENT

It has now been found that processing and storage containers (e.g., beer kegs, diary containers, and wine containers) and related parts can be effectively and efficiently cleaned with an aqueous solution of phosphoric acid, nitric acid and a detergent and/or wetting agent with a total nitric acid composition of 12 wt % or less being preferred.

The combination of nitric and phosphoric acids is particularly useful for cleaning the residue inside of beer, wine, and dairy processing and storage containers. Nitric acid (HNO₃) is extremely reactive with organic soil. Unlike phosphoric, sulfuric, and hydrochloric acid, which are mineral acids, nitric acid is an oxidizing acid which assists in breaking down the amino acids which are the building blocks of protein. In addition, nitric acid is known by those skilled in the art of metallurgy as being a “passivating” acid, which means that it leaves stainless steel in a “passive” state so the metal is not corroded by the beer, wine, milk, and salts in water. Phosphoric acid (H₃PO₄) is used in the formulation act as a pH buffer. While nitric acid only has one acid site, phosphoric acid has three acid sites.

Phosphoric acid is preferably used in an amount of from about 2-34%¹ of the cleaning additive for the aqueous solution. Nitric acid is preferably used in an amount of about 4-20% and more preferably in an amount of about 6-12%. It is also possible that these acids could be substituted in part with some other type of mineral acid, namely sulfuric acid. Unless otherwise indicated, all percentages are on a weight per weight basis. ¹ Unless otherwise indicated, all percentages are on a weight per weight basis.

In general, the phosphoric and nitric acid component can comprise:

| | |
|---|---|
| Phosphoric acid | 2-34% active |
| Triton CF 32 | 0.5-1.0% |
| Nitric acid | 4-33% |
| Water | balance water |

A useful blend of acids is:

| | |
|---|---|
| Phosphoric acid | 4-8% active |
| Triton CF 32 | 0.5-1.0% |
| Nitric acid | 12% active |
| Water | balance |

Such a formulation is sold under the designation “Ultra Niter™” by Birko Corporation of Henderson, Colo. Ultra Niter™ is a nitric acid/phosphoric acid blend that has been employed as a passivating and/or descaling acid and as a caustic neutralizer in both the meat packing and brewery industries.

Another useful blend of acids is:

| | |
|---|---|
| Phosphoric acid | 4-8% active |
| Buffer (e.g., phosphate buffer) | 0.5-1.0% |
| Nitric acid | 33% active |
| Water | balance |

Such a formulation is sold under the designation “Nitro CIP™” by Birko Corporation of Henderson, Colo. Nitro CIP™ is a nitric acid/phosphoric acid blend that has been employed as a passivating and/or descaling acid and as a caustic neutralizer in both the meat packing and brewery industries.

While nitric and phosphoric acid are useful cleaning agents, by themselves, they are not particularly good at penetrating the soil residues inside used kegs, wine containers, or dairy containers. Accordingly, it is helpful to employ one or more surfactants, particularly those that “wet out” and reduce the surface tension of the soil, so that the cleaning solution can penetrate deeply. Generally, non-ionic, alcohol ethoxylated surfactants that can perform this function are useful. In addition, the use of polymer dispersing agents is helpful to keep the penetrated soils in suspension. Generally, at least about 2-3% of one or more appropriate surfactants should be employed.

Because nitric acid is an oxidizing acid, it is difficult to find a compatible surfactant.

A particularly useful wetting agent is a blend of the following:

| | |
|---|---|
| Acumer 5000 | 1.17% |
| (a polymer available from Rohm & Haas, Philadelphia, PA) | |
| Acusol 505-N | 2.34% |
| (a polymer available from Rohm & Haas, Philadelphia, PA) | |
| Rhodoline 142 | 1.17% |
| (a polymer available from Rhodia, Inc., Cranbury, NJ) | |
| or Dequest 2000 (Brenntag, Antwerp, Belgium) | |
| Briquest 301-50A | 1.17% |
| (a sequesterant available from ThermPhos, Switzerland) | |
| Genapol UD-080 | 5.85% |
| (a non-ionic surfactant available | |
| from Huntsman, Woodlands, TX) | |
| Makon NF-12 | 5.85% |
| (a non-ionic surfactant available from | |
| Stepan Company, Northfield, IL) | |
| PnP Solvent | 5.85% |
| (a solvent available from Huntsman, Woodlands, TX) | |
| Bioterge PAS-8S | 5.85% |
| (Stepan Company, Northfield, IL) | |
| Genapol UD-030 | 2.34% |
| (a non-ionic surfactant available | |
| from Huntsman, Woodlands, TX) | |
| Citric Acid, Anhyd. FG | 1.17% |
| (an organic acid available from Univar, Redmond, WA) | |
| Triton CF 32 | 1.75% |
| (a non-ionic surfactant available | |
| from Dow Chemical, Midland, MI) | |
| Water (deionized) | balance |

The foregoing formulation is sold under the designation “X-Puma™” by Birko Corporation of Henderson, Colo. X-Puma™ is a detergent additive that has generally been employed as an acid or caustic aid in both the meat packing and brewing industries.

The acids and surfactant should be blended to form an aqueous solution effective for removing the residue from and cleaning kegs and dairy/wine containers or tanks In one preferred embodiment about 1-2 oz. of Ultra Niter™ and about 250-500 ppm of X-Puma™ can be employed per gallon of water.

The acids and surfactant of the present method can be blended to form an aqueous solution for use in Clean-in-Place (CIP) methods, which is a method of cleaning the interior surfaces of pipes, vessels, process equipment, filters and associated fittings, without disassembly. CIP cleaning is utilized to clean interior surfaces of tanks and pipelines of liquid process equipment. The chemical solution of the present disclosure can be circulated through a circuit of tanks and or lines then returned to a central reservoir allowing for reuse of the chemical solution. Time, temperature, and mechanical force can be manipulated to achieve maximum cleaning.

In particular embodiments, the present method can be used in bright beer tanks, which are vessels in which beer is placed after primary fermentation where the beer matures, clarifies and, is naturally carbonated through secondary fermentation. These tanks are also called conditioning tanks, serving tanks, and secondary tanks.

The present method can also be used to remove milkstone and hard water deposits from dairy equipment, such as bulk tanks, pipeline cleaners, milking machines, utensils, and other dairy equipment.

In yet another embodiment, the method can be used to remove calcium tartrate from wine making and storage equipment, such as tanks and pipes.

The resulting pH of the solution at dilution should be in the range of about 1.0-1.5. At this pH, any remaining microbes should be destroyed and the protein and beerstone/milkstone/calcium tartrate removed as well.

The aqueous solution of the present invention can be used in any standard, commercial method for processing/storage containers either manually or via automation. In a particular embodiment, the acid and detergent/wetting agent components can be used in an aqueous solution at about 120-140° F. An advantage of the present invention is that cleaning can be effectively accomplished without using extremely high water temperatures. Using a temperature in excess of 140° F. can “set” protein and deposits (beerstone, milkstone, calcium tartrate, etc.) making more difficult to remove later.

In another process of the present invention, a used container, such as a keg, is rinsed first with potable warm water. This is particularly helpful when the keg contains the residue from unfiltered beer. Subsequently, the cleaning solution is then employed to clean and remove residue from the keg and finally the keg is subjected to “triple rinsing” with warm water. All of these steps can be accomplished with water at a maximum temperature of 140° F.

Another advantage of the present invention is that the cleaning solution is not neutralized by carbon dioxide (CO₂) remaining in kegs. Typically the carbon dioxide neutralizes the sodium hydroxide, caustic reducing the pH and the cleaning efficacy. The method of the present invention doesn't have this problem and is unaffected by residual carbon dioxide in the used kegs. Likewise, unless all of the CO2 is removed from a primary fermenter in the wine industry, the same problem of neutralizing caustic occurs. If the dairy industry “blankets” (puts CO2 on top of) milk tanks with CO2 in order to avoid aerobic organism spoilage, the same problem will occur.

The use of the present invention is beneficial in that: (a) it results in complete cleaning of the containers or vessels without the use of caustic, (b) it is safe and provides minimal risk to workers; and (c) it is inexpensive in that the cleaning solution itself is less expensive and in that the cleaning solution can be continuously recycled for additional container cleaning operations. Indeed, one of the surprising results of the invention has been the ability to continuously recycle the cleaning solution for several weeks or more thereby providing economic benefits far in excess of those anticipated.

### Example I

A test was performed at a commercial micro-brewery that traditionally used about 190 ml of chlorinated caustic (i.e., more than 6.4 ounces) per keg for cleaning The spent caustic was not recycled, and the process was very costly.

Subsequently, the micro-brewery employed an automated keg cleaning and sanitizing machine with a 60 gallon reservoir for recycling the cleaning solution. The keg cleaning and sanitizing machine is a commercially available machine from Comac/Eurosource, Inc. 2351 W. Northwest Hwy. Ste. 1105 Dallas, Tex. 75220. The Comac machine performed the cleaning operation as follows:
a compressed air purge to remove any remaining beer and carbon dioxide from the keg,
a hot water rinse,
a cleaning cycle with cleaning solution from the reservoir,
three burst rinses with hot water, and
a steam sanitizing cycle.

To prepare the cleaning solution, the 60 gallon reservoir was filled with water and charged with one gallon of Ultra Niter™ acid combination and two ounces of X-Puma™ detergent additive. The resulting aqueous cleaning solution contained about 2 ounces per gallon of the nitric/phosphoric acid blend and only about 250 parts-per-million (ppm) of the detergent additive. The Ph of the solution was 1.0-1.5. The solution also tested out to 3000 ppm as phosphoric acid using a LaMotte Acidity test kit.

The micro-brewery used the cleaning solution in the manner indicated to clean and sanitize hundreds of kegs from a single charging of the reservoir. Used cleaning solution from the process was recycled to the reservoir and repeatedly reused. The tank was dumped after 2-3 weeks of use, not because of any perceived deficiency in the cleaning solution—but out of an abundance of caution. During that time period, kegs were cleaned in a commercially acceptable manner, i.e., removal of soil with no remaining contamination. At the end of the test, the remaining solution was safely poured down a floor drain into a catch basin.

### Example II

A cleaning solution is prepared and used as discussed in Example I, except that the 60 gallon reservoir is filled with water and charged with one gallon of Nitro CIP™ acid combination and two ounces of X-Puma™ detergent additive. The resulting aqueous cleaning solution contains about 2 ounces per gallon of the nitric/phosphoric acid blend and only about 250 parts-per-million (ppm) of the detergent additive. The Ph of the solution is maintained at 1.0-1.5.

### Example III

The cleaning solution of Example II is used to clean and sanitize of wine steel tanks Used cleaning solution from the process is recycled to the reservoir and repeatedly reused. The tank is dumped after 2-3 weeks of use, not because of any perceived deficiency in the cleaning solution—but out of an abundance of caution. During that time period, wine steel tanks are cleaned in a commercially acceptable manner, i.e., removal of soil with no remaining contamination. At the end of the test, the remaining solution is safely poured down a floor drain into a catch basin.

### Example IV

The cleaning solution of Example II is used to clean and sanitize of dairy tanks Used cleaning solution from the process is recycled to the reservoir and repeatedly reused. The tank is dumped after 2-3 weeks of use, not because of any perceived deficiency in the cleaning solution—but out of an abundance of caution. During that time period, dairy tanks are cleaned in a commercially acceptable manner, i.e., removal of soil with no remaining contamination. At the end of the test, the remaining solution is safely poured down a floor drain into a catch basin.

What is claimed is:

1. A method for cleaning a used liquid storage or processing container without application of a caustic, the method comprising cleaning the storage or processing container with an aqueous cleaning solution comprising phosphoric acid, nitric acid, one or more polymer dispersing agents, water and a wetting agent, the aqueous cleaning solution having a total nitric acid content of between about 4 wt % and 33 wt % and having a wetting agent content of at least about 2 wt %, wherein the wetting agent comprises one or more non-ionic surfactants.

2. The method of claim 1, wherein the phosphoric acid comprises 2-34 wt %.

3. The method of claim 1 wherein the aqueous cleaning solution is recycled for subsequent cleaning treatments.

4. The method of claim 1, wherein the container is a beer keg.

5. The method of claim 1, wherein the container is a container for storing or processing wine.

6. The method of claim 1, wherein the container is a container for storing or processing dairy products.

7. The method of claim 6, wherein the container is a container for storing or processing milk.
